(19) United States
(12) Patent Application Publication
(10) Pub. No.: US 2020/0039324 A1
(43) Pub. Date: Feb. 6, 2020

(54) HEAT MEDIUM HEATING DEVICE, AND VEHICULAR AIR CONDITIONING DEVICE

(71) Applicant: MITSUBISHI HEAVY INDUSTRIES THERMAL SYSTEMS, LTD., Tokyo (JP)

(72) Inventor: Tomoyasu ADACHI, Tokyo (JP)

(73) Assignee: MITSUBISHI HEAVY INDUSTRIES THERMAL SYSTEMS, LTD., Tokyo (JP)

(21) Appl. No.: 16/482,573

(22) PCT Filed: Jan. 18, 2018
(86) PCT No.: PCT/JP2018/001363

§ 371 Date: Jul. 31, 2019

(30) Foreign Application Priority Data
Feb. 17, 2017 (JP) 2017-027930

(51) Int. Cl. B60H 1/22; H05B 1/02

(52) U.S. Cl. CPC B60H 1/2218; H05B 2203/02; H05B 1/0236; B60H 1/2225

(57) ABSTRACT

A first casing part (41), a second casing part (42) removable from the first casing part (41), a first screw (38) configured to secure a distal end portion (66A) of a first terminal (66) to a first connection portion (83), and a second screw configured to secure a distal end portion of a second terminal to a second connection portion are provided, the distal end portion (66A) of the first terminal (66) and the first connection portion (83) are disposed facing each other in a Z direction, and the distal end portion of the second terminal and the second connection portion are disposed facing each other in the Z direction.

### TECHNICAL FIELD

The present invention relates to a heat medium heating device and a vehicular air conditioning device including the heat medium heating device.

This application claims priority based on JP 2017-027930 filed in Japan on Feb. 17, 2017, of which the contents are incorporated herein by reference.

### BACKGROUND ART

There is a heat medium heating device constituting a known vehicular air conditioning device and including a Positive Temperature Coefficient (PTC) heater in which a PTC element serves as a heat generating element.

Patent Document 1 discloses a heat medium heating device including a PTC heater, a control board, and a casing configured to house the PTC heater and the control board in a stacked state.

The PCT heater includes a PTC element and a pair of electrode plates, and the pair of electrode plates include terminals extending in a stacking direction of the PTC heater and the control board and are provided on both faces of the PTC element.

The terminals of the pair of electrode plates are screwed, and thus the control board is electrically connected to the pair of electrode plates. The control board performs electrification control of the PTC heater.

Patent Document 1 discloses providing a window for operation on a side wall of the casing to screw the terminals of the pair of electrode plates from an orthogonal direction orthogonal to the stacking direction of the PTC heater and the control board.

### CITATION LIST

### Patent Literature

Patent Document 1: JP 2013-220706 A

### SUMMARY OF INVENTION

### Technical Problem

However, in the case such as the heat medium heating device disclosed in Patent Document 1 where the screwing operation is performed from the side of the casing through the window for operation, there has a possibility of making the screwing operation difficult, and reducing operating efficiency.

Thus, an object of the present invention is to provide a heat medium heating device and a vehicular air conditioning device capable of increasing operating efficiency in screwing a terminal of an electrode plate to a control board.

### Solution to Problem

To solve the above-described problem, a heat medium heating device according to an aspect of the present invention includes a PTC heater including a PTC element including a first face and a second face, a first electrode plate provided on the first face of the PTC element and including a first terminal, and a second electrode plate provided on the second face of the PTC element and including a second terminal, a control board including a first connection portion to which the first terminal is connected, and a second connection portion to which the second terminal is connected, a casing configured to house the PTC heater and the control board in a stacked state, and including a first casing part disposed on a first face side of the PTC element and including a first heat medium flow path through which a heat medium flows, and a second casing part disposed on a second face side of the PTC element, including a second heat medium flow path through which a heat medium flows, and removable from the first casing part, a first screw configured to secure a distal end portion of the first terminal to the first connection portion, and a second screw configured to secure a distal end portion of the second terminal to the second connection portion, wherein a distal end portion of the first terminal and the first connection portion are disposed facing each other in a stacking direction of the PTC heater and the control board, and a distal end portion of the second terminal and the second connection portion are disposed facing each other in a stacking direction of the PTC heater and the control board.

According to the present invention, the first casing part, the second casing part removable from the first casing part, the first screw configured to secure the distal end portion of the first terminal to the first connection portion, and the second screw configured to secure the distal end portion of the second terminal to the second connection portion are provided. The distal end portion of the first terminal and the first connection portion are disposed facing each other in the stacking direction of the PTC heater and the control board, and the distal end portion of the second terminal and the second connection portion are disposed facing each other in the stacking direction of the PTC heater and the control board. Thus, the first and second screws can be screwed into from the stacking direction of the PTC heater and the control board in a state where the second casing part is removed from the first casing part.

Accordingly, a necessity for providing a window for operation on a side wall of the casing is eliminated, and operating efficiency in screwing the first and second connection portions with the first and second screws can be increased as compared to screwing through a window for operation from a side wall side of the casing.

In addition, according to the configuration described above, the first and second screws can be screwed into while a positional relationship between the first and second connection portions and the first and second terminals are confirmed.

In addition, in the heat medium heating device according to an aspect of the present invention, the first and second terminals may include at least two bending portions.

In this manner, the first and second terminals include at least the two bending portions, and thus the distal end portion of the first terminal and the first connection portion can be disposed facing each other in a stacking direction of the PTC heater and the control board, and the distal end portion of the second terminal and the second connection portion can be disposed facing each other in the stacking direction of the PTC heater and the control board.

Accordingly, in a state where the second casing part is removed from the first casing part, the distal end portion of the first terminal can be screwed to the first connection portion and the distal end portion of the second terminal can be screwed to the second connection portion by using a tool in the stacking direction of the PTC heater and the control board.

In addition, in the heat medium heating device according to an aspect of the present invention, an insulating member surrounding an outer peripheral face of the PTC heater and being in contact with an inner face of the casing may be provided.

The insulating member configured in this manner is provided, and thus insulation can be achieved between a conductor disposed in a periphery of a side face of the PTC heater and the side face of the PTC heater, while positioning of the PTC heater with respect to the control board can be performed.

In addition, in the heat medium heating device according to an aspect of the present invention, the insulating member may include a first guide portion including a first opening through which the first terminal is inserted and a second guide portion including a second opening through which the second terminal is inserted, and the first and second openings may extend in a stacking direction of the PTC heater and the control board.

The first and second guide portions configured in this manner are provided, and thus insulation can be achieved between a conductor disposed in a periphery of the first and second terminals and the first and second terminals.

In addition, in the heat medium heating device according to an aspect of the present invention, a heat medium introduced into the casing may flow branching into the first and second heat medium flow paths.

In this way, the heat medium introduced into the casing may flow branching into the first and second heat medium flow paths.

A vehicular air conditioning device according to an aspect of the present invention may include the heat medium heating device described above, a blower configured to circulate an outside air or a cabin inside air, a cooler provided on a downstream side of the blower and configured to cool the outside air or the air, and a radiator which is provided on a downstream side of the cooler and in which the heat medium heated by the PTC heater is circulated.

The vehicular air conditioning device includes the heat medium heating device in this manner, and thus operating efficiency in screwing the first and second terminals to the control board can be increased.

### Advantageous Effect of Invention

According to the present invention, operating efficiency in screwing a terminal of an electrode plate to a control board can be increased.

### BRIEF DESCRIPTION OF DRAWINGS

FIG. 1 is a view schematically illustrating a schematic configuration of a vehicular air conditioning device according to an embodiment of the present invention.

FIG. 2 is a perspective view illustrating an appearance of a heat medium heating device illustrated in FIG. 1.

FIG. 3 is an exploded perspective view of the heat medium heating device illustrated in FIG. 2.

FIG. 4 is a schematic cross-sectional view in an A₁-A₂ line direction of the heat medium heating device illustrated in FIG. 2.

FIG. 5 is a schematic cross-sectional view in a B₁-B₂ line direction of the heat medium heating device illustrated in FIG. 2.

FIG. 6 is a schematic cross-sectional view in a C₁-C₂ line direction of the heat medium heating device illustrated in FIG. 2.

FIG. 7 is a plan view schematically illustrating a PTC heater screwed to a control board illustrated in FIG. 2.

FIG. 8 is a schematic cross-sectional view in a D₁-D₂ line direction of the heat medium heating device illustrated in FIG. 2.

### DESCRIPTION OF EMBODIMENT

An embodiment in which the present invention is applied will be described below in detail with reference to the drawings.

### Embodiment

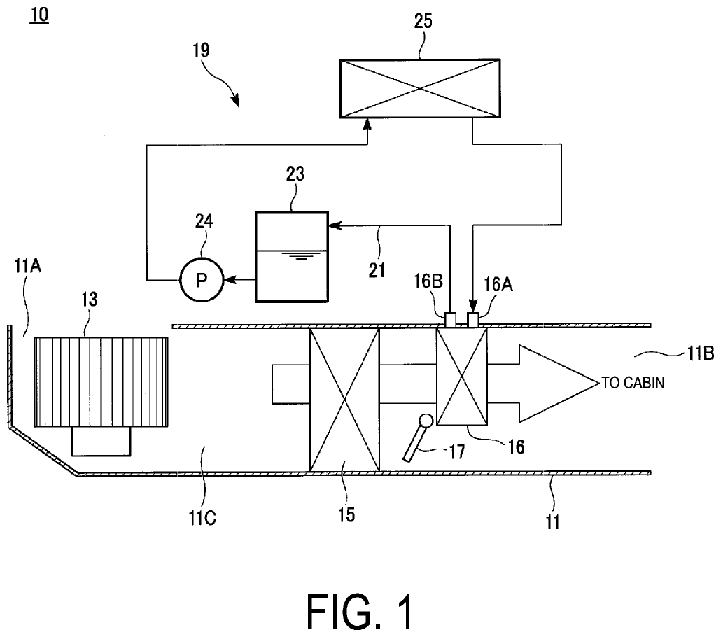

A vehicular air conditioning device 10 according to the present embodiment will be described with reference to FIG. 1. An arrow illustrated in FIG. 1 indicates a flow direction of an outside air or a cabin inside air.

The vehicular air conditioning device 10 is, for example, an air conditioning device that can be applied to a hybrid vehicle, an electric vehicle, and the like.

With reference to FIG. 1, the vehicular air conditioning device 10 includes a housing 11, a blower 13, a cooler 15, a radiator 16 constituting a heat medium circulation circuit 19, an air mixing damper 17, and the heat medium circulation circuit 19 including a heat medium heating device 25.

The housing 11 includes an intake port 11A, a discharge port 11B, and a flow path 11C. The intake port 11A is an opening configured to take an outside air or a cabin inside air (hereinafter simply referred to as “air”) into the flow path 11C. The discharge port 11B connects air having passed through the flow path 11 to a plurality of blown-out ports provided in a cabin. The flow path 11C is a path through which air flows and is defined in the housing 11.

The blower 13 is provided near the intake port 11A in the housing 11. The blower 13 draws air from the intake port 11A and pumps air sucked to a downstream side of the blower 13.

The cooler 15 is provided in the housing 11 positioned on the downstream side of the blower 13. The cooler 15 is disposed to block a portion of the flow path 11C. The cooler 15 constitutes a refrigerant circuit together with a compressor, a condenser, and an expansion valve which are not illustrated. The cooler 15 cools air passing through the cooler 15 by evaporating a refrigerant adiabatically expanded by the expansion valve, and supplies air cooled to a downstream side of the cooler 15.

The radiator 16 constitutes the heat medium circulation circuit 19 together with a circulation line 21, a tank 23, a pump 24, an engine (not illustrated), and the heat medium heating device 25. The radiator 16 is provided in the flow path 11C positioned on the downstream side of the cooler 15.

The radiator 16 includes an inlet port 16A and an outlet port 16B connected to the circulation line 21.

A heat medium is introduced through the circulation line 21 into the inlet port 16A via the heat medium heating device 25. The heat medium having passed through the radiator 16 is guided out of the outlet port 16B to the circulation line 21.

The radiator 16 exchanges heat between the air cooled by the cooler 15 and the heat medium to heat air and supply air heated to the downstream side.

The air mixing damper 17 is provided in the flow path 11C positioned between the cooler 15 and the radiator 16. The air mixing damper 17 is a damper configured to adjust a ratio of an amount of air having passed through the radiator 16 to an amount of air flowing bypassing the radiator 16. The air mixing damper 17 has a function to adjust a temperature of air to be mixed downstream of the air mixing damper 17.

The heat medium circulation circuit 19 includes the radiator 16, the circulation line 21, the tank 23, the pump 24, the engine (not illustrated), and the heat medium heating device 25.

The heat medium circulation circuit 19 heats an engine cooling fluid by the heat medium heating device 10 when a temperature of the engine cooling fluid which is a heat medium does not rise appreciably, for example, during a hybrid operation and the like. Then, an engine cooling fluid heated is circulated through the circulation line 21 by the pump 24, and thus air passing through the radiator 16 is warmed in the housing 11.

The circulation line 21 is disposed outside the housing 11. The circulation line 21 connects the radiator 16, the tank 23, the pump 24, the engine (not illustrated), and the heat medium heating device 25. The circulation line 21 is a line configured to circulate the heat medium.

When the vehicular air conditioning device 10 is applied to a hybrid vehicle, for example, an engine cooling fluid of a hybrid vehicle can be used as the heat medium. In a case where the vehicular air conditioning device 10 is applied to an electric vehicle that does not include an engine, for example, a brine or the like can be used as the heat medium.

The tank 23 is provided in the circulation line 21 positioned on the outlet port 16B side. The heat medium is stored in the tank 23.

The pump 24 is provided in the circulation line 21 positioned on a downstream side of the tank 23. The pump 24 supplies the heat medium in the tank 23 to the heat medium heating device 25.

The heat medium heating device 25 is provided in the circulation line 21 positioned between the pump 24 and the radiator 16.

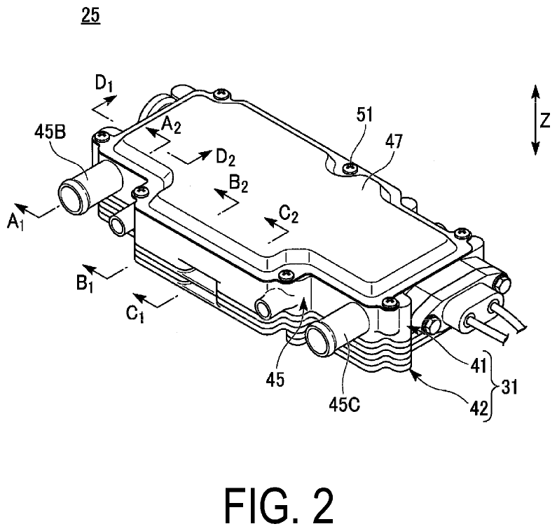

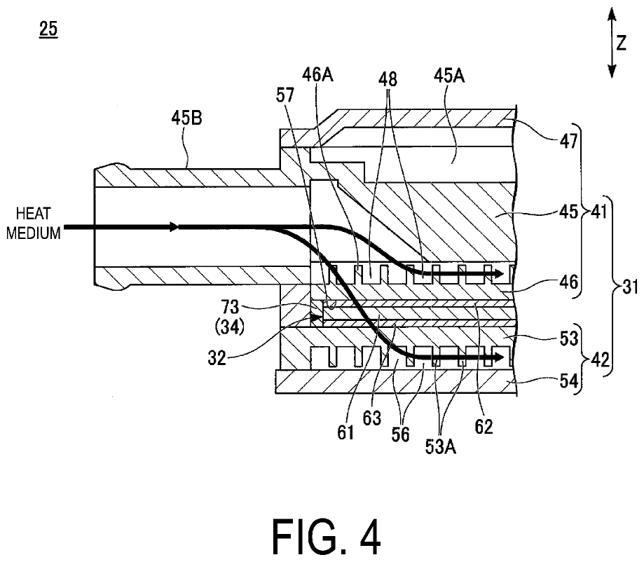

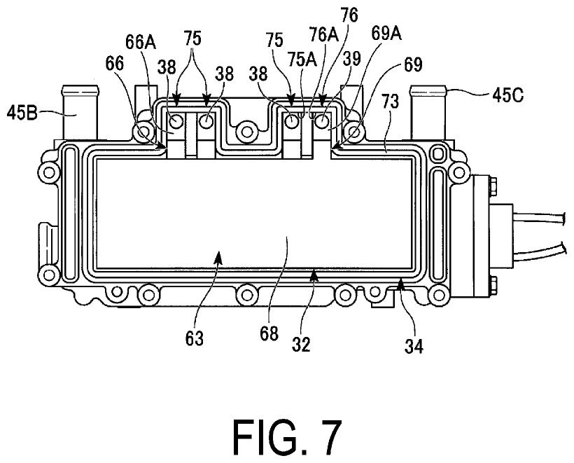

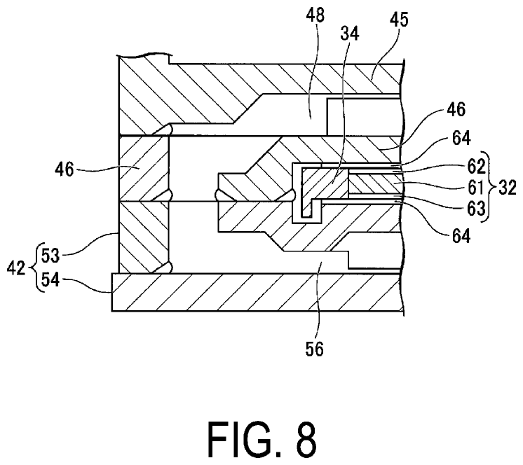

A configuration of the heat medium heating device 25 will be described with reference to FIGS. 2 to 5. A Z direction illustrated in FIGS. 2 to 5 indicates a stacking direction of a PTC heater 32 and a control board 37. In FIGS. 2 to 8, the same constituent components are denoted by the same reference signs. An arrow illustrated in FIG. 4 indicates a state where the heat medium flows into two branches. In addition, FIG. 7 illustrates a state where a second casing part 42 has been removed from a first casing part 41. In FIG. 8, only a lower portion of the heat medium heating device is illustrated in a cross-sectional view.

The heat medium heating device 25 includes a casing 31, the PTC heater 32, an insulating member 34, the control board 37, a first screw 38, and a second screw 39.

The casing 31 includes the first casing part 41 and the second casing part 42. The first casing part 41 and the second casing part 42 are configured to be separable (a configuration in which one part is removable from the other part).

The first casing part 41 is disposed on a first face 61a side of a PTC element 61 that constitutes the PTC heater 32. The first casing part 41 is secured to the second casing part 42 with a screw or the like. The first casing part 41 includes a board accommodating portion 45, a flow path-forming portion 46, and a lid portion 47.

The board accommodating portion 45 is provided between the flow path-forming portion 46 and the lid portion 47. The board accommodating portion 45 includes a board accommodating recess 45A, a heat medium inlet port 45B, and a heat medium outlet port 45C. The board accommodating recess 45A is a recessed portion that accommodates the control board 37.

The heat medium inlet port 45B is connected to the circulation line 21 that circulates the heat medium. The heat medium inlet port 45B introduces the heat medium into first and second heat medium flow paths 48, 56 formed in the casing 31.

The heat medium outlet port 45C is connected to the circulation line 21. The heat medium outlet port 45C guides the heat medium having passed through the first and second heat medium flow paths 48, 56 provided in the casing 31 out to the circulation line 21.

The flow path-forming portion 46 is a plate-like member, and includes a plurality of fins 46A in a portion facing the board accommodating portion 45. The plurality of fins 46A project in a direction oriented to the board accommodating portion 45.

The first heat medium flow path 48 is defined between the flow path-forming portion 46 and the board accommodating portion 45. The first heat medium flow path 48 is a plurality of parallel flow paths. The first heat medium flow path 48 is in communication with the heat medium inlet port 45B and the heat medium outlet port 45C. The first heat medium flow path 48 is disposed to face one face of the PTC heater 32.

The lid portion 47 is configured to be separable with respect to the board accommodating portion 45. The lid portion 47 is secured with a screw 51. The lid portion 47 faces the control board 37.

The second casing part 42 is disposed on a second face 61b side of the PTC element 61. The second casing part 42 includes a flow path-forming portion 53 and a lid portion 54.

The flow path-forming portion 53 is a plate-like member, and is provided between the flow path-forming portion 46 and the lid portion 54. The flow path-forming portion 53 includes a plurality of fins 53A in a portion facing the lid portion 54. The plurality of fins 53A project in a direction oriented to the lid portion 54.

The second heat medium flow path 56 is defined between the plurality of fins 53A and the lid portion 54.

The second heat medium flow path 56 is a plurality of parallel flow paths, and is in communication with the heat medium inlet port 45B and the heat medium outlet port 45C. The second heat medium flow path 56 is disposed to face the other face of the PTC heater 32.

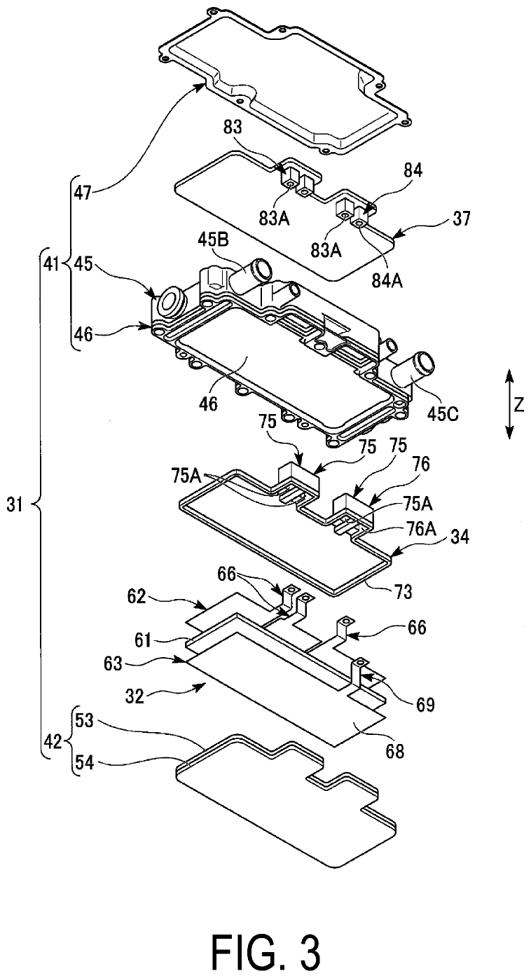

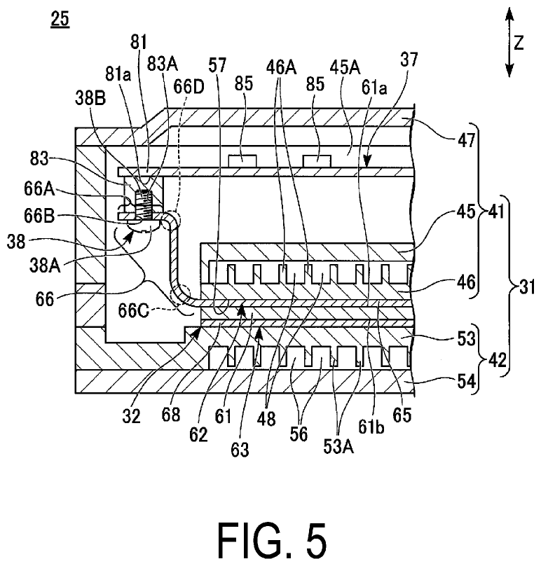

A space 57 in which the PTC heater 32, a compressible sheet (not illustrated in FIGS. 3 to 7) and the insulating member 34 (not illustrated in FIGS. 4 and 5) are housed is formed between the flow path-forming portion 46 and the flow path-forming portion 53.

As illustrated in FIG. 8, both the faces of the PTC heater 32 are covered with a compressible heat transmission sheet 64 made from a silicon sheet or the like. In addition, the insulating member 34 is provided on a peripheral edge of the PTC heater 32.

The PTC heater 32 is disposed in the space 57. The PTC heater 32 includes an PTC element 61, a first electrode plate 62, and a second electrode plate 63.

The PTC element 61 is a rectangular plate-shaped element and is disposed between the first electrode plate 62 and the second electrode plate 63. The PTC element 61 includes the first face 61a and the second face 61b. The first face 61a faces the first heat medium flow path 48 provided in the first casing part 41 in the Z direction.

The second face 61b is a face disposed opposite the first face 61a. The second face 61b faces the second heat medium flow path 56 provided in the second casing part 42 in the Z direction.

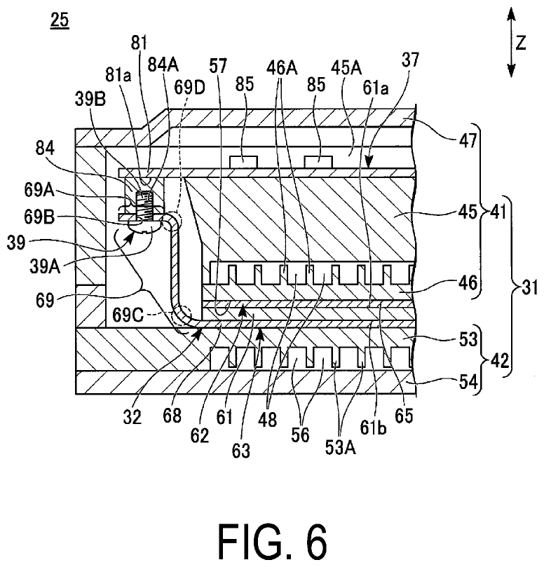

Note that although only one PTC element 61 is illustrated in FIGS. 5 and 6, a plurality of the PTC elements 61 may be provided between the first electrode plate 62 and the second electrode plate 63.

The first electrode plate 62 includes a first electrode main body 65 divided into three, and three first terminals 66. The first electrode main body 65 is a plate-like electrode formed in a rectangular shape. The first electrode main body 65 is provided on the first face 61a of the PTC element 61.

A first terminal 66 is provided for each of the first electrode main body 65 divided into three. Of the three first terminals 66, the two terminals are disposed adjacent to each other, and the remaining one terminal is provided at a position spaced apart from the other two terminals.

The three first terminals 66 extend from an end of the first electrode main body 65 outside the PTC element 61 and in a direction oriented to the control board 37. The three first terminals 66 each have a shape in which a plate member is bent at two locations.

Each of the three first terminals 66 include a distal end portion 66A in which a through hole 66B is formed, and bending portions 66C, 66D. The through hole 66B is a hole into which a shaft 38B of the first screw 38 is inserted. The distal end portion 66A is a portion being in contact with a first connection portion 83 that constitutes the control board 37.

The bending portion 66C is disposed in the vicinity of the PTC element 61. The bending portion 66C is a portion that is bent to bring an extension direction of the three first terminals 66 into a direction oriented to the control board 37 (Z direction).

The bending portion 66D is disposed in the vicinity of the distal end portion 66A. The bending portion 66D is a portion that is bent to bring an extension direction of the distal end portion 66A into a direction orthogonal to the Z direction.

Each of the three first terminals 66 includes the two bending portions 66C, 66D in this manner, and thus the distal end portion 66A of each of the three first terminals 66 and the control board 37 (specifically, the first connection portion 83 described below) can be disposed facing each other in the Z direction.

Accordingly, in a state where the second casing part 42 has been removed from the first casing part 41, the distal end portion 66A of each of the three first terminals 66 can be screwed to the first connection portion 83 of the control board 37 by using a tool in the stacking direction (Z direction) of the PTC heater 32 and the control board 37.

The second electrode plate 63 includes a second electrode main body 68 and a second terminal 69. The second electrode main body 68 is a plate-like electrode formed in a rectangular shape. The second electrode main body 68 is provided on the second face 61b of the PTC element 61.

One second terminal 69 is provided, out of two long sides of the second electrode main body 68, on a long side positioned on the side where the first terminals 66 are provided. The second terminal 69 is disposed adjacent to one of the three first terminals 66 provided at a position spaced apart from the two first terminals 66.

The second terminal 69 extends from an end of the second electrode main body 68 outside the PTC element 61 and in a direction oriented to the control board 37. The second terminal 69 has a shape in which a plate member is bent at two locations.

The second terminal 69 includes a distal end portion 69A in which a through hole 69B is formed, and bending portions 69C and 69D. The through hole 69B is a hole into which the shaft 38B of the first screw 38 is inserted. The distal end portion 69A is a portion being in contact with a second connection portion 84 constituting the control board 37.

The bending portion 69C is disposed in the vicinity of the PTC element 61. The bending portion 69C is a portion that is bent to bring an extension direction of the second terminal 69 into a direction oriented to the control board 37 (Z direction).

The bending portion 69D is disposed in the vicinity of the distal end portion 69A. The bending portion 69D is a portion that is bent to bring an extension direction of the distal end portion 69A into a direction orthogonal to the Z direction.

The second terminal 69 includes the two bending portions 69C, 69D in this manner, and thus the distal end portion 69A of the second terminal 69 and the control board 37 (specifically, the second connection portion 84 described below) can be disposed facing each other in the Z direction.

Accordingly, in a state where the second casing part 42 has been removed from the first casing part 41, the distal end portion 69A of the second terminal 69 can be screwed to the second connection portion 84 of the control board 37 by using a tool in the stacking direction (Z direction) of the PTC heater 32 and the control board 37.

The PTC heater 32 configured as described above heats the heat medium flowing through the first and second heat medium flow paths 48, 56. The heat medium heated by the PTC heater 32 is introduced into the radiator 16 through the inlet port 16A of the radiator 16.

Note that an insulating plate (not illustrated) is provided between the PTC heater 32 and the flow path-forming portions 46, 53. This insulating plate insulates between the PTC heater 32 and the flow path-forming portions 46, 53.

In addition, although FIG. 3 illustrates as an example the case where the three first terminals 66 and the one second terminal 69 are provided, the number of the first and second terminals 66 and 69 is not limited to the number of divisions described in the present embodiment.

Further, although FIGS. 3, 5, and 6 illustrate as an example the case in which the first and second terminals 66, 69 each include the two bending portions (the bending portions 66C, 66D or the bending portions 69C, 69D), the number of the bending portions of the first and second terminals 66, 69 may be two or more, and is not limited to two.

The insulating member 34 includes a frame body 73, a first guide portion 75, and a second guide portion 76. The frame body 73 has a shape that surrounds a side face of a structure including the first electrode main body 65, the PTC element 61, and the second electrode main body 68.

The frame body 73 is disposed between the flow path-forming portion 46 and the flow path-forming portion 53 in a state where the frame body 73 surrounds the side face of the structure including the first electrode main body 65, the PTC element 61, and the second electrode main body 68. An outer peripheral face of the frame body 73 abuts an inner face of the casing 31.

Three first guide portions 75 are provided on a long side of the frame body 73. The two first guide portions 75 are provided adjacent to each other. The remaining one first guide portion 75 is provided spaced apart from the other two first guide portions 75.

The first guide portions 75 each include a first opening 75A into which the first terminal 66 is inserted and which extends in the Z direction. The first guide portions 75 are each shaped to surround the first terminal 66.

The first guide portions 75 configured in this manner are provided, and thus insulation can be achieved between a conductor disposed in the periphery of the first terminal 66 and the first terminal 66.

One second guide portion 76 is provided on the long side of the frame body 73 on which the first guide portions 75 are provided. The second guide portion 76 is disposed adjacent to one first guide portion 75.

The second guide portion 76 includes a second opening 76A into which the second terminal 69 is inserted and which extends in the Z direction. The first guide portion 75 is shaped to surround the first terminal 66.

The second guide portion 76 configured in this manner is provided, and thus insulation can be achieved between a conductor disposed in the periphery of the second terminal 69 and the second terminal 69.

The insulating member 34 configured as described above is provided, and thus insulation can be achieved between a conductor disposed in the periphery of the side face of the PTC heater 32 and the side face of the PTC heater 32, and positioning of the PTC heater 32 with respect to the control board 37 can also be performed.

The control board 37 includes a board main body 81, a first connection portion 83, a second connection portion 84, and an electronic component 85.

The board main body 81 includes a configuration in which a circuit pattern (a control circuit pattern, a power supply circuit pattern, or the like) is formed on a face of a circuit board having a plate-like shape. The board main body 81 is secured with a screw or a bolt on the board accommodating portion 45. The board main body 81 includes a face 81a that faces the board accommodating portion 45.

The first connection portion 83 is a terminal base, and three first connection portions 83 are provided on an outer periphery of the face 81a of the board main body 81. The first connection portion 83 is disposed at a position facing the distal end portion 66A of the first terminal 66. The first connection portion 83 projects from the face 81a of the board main body 81 in the Z direction oriented to the second casing part 42. The first connection portion 83 is electrically connected to the board main body 81. The first connection portion 83 is provided with a screw hole 83A facing the through hole 66B.

The second connection portion 84 is a terminal base, and one second connection portion 84 is provided on the outer periphery of the face 81a of the board main body 81. The second connection portion 84 is disposed at a position facing the distal end portion 69A of the second terminal 69. The second connection portion 84 projects from the face 81a of the board main body 81 in the Z direction oriented to the second casing part 42. The second connection portion 84 is electrically connected to the board main body 81. The second connection portion 84 is provided with a screw hole 84A facing the through hole 69B.

The electronic component 85 is mounted in the board main body 81. The electronic component 85 is electrically connected to the board main body 81. As the electronic component 85, an electronic component having pyrogenicity such as an Insulated Gate Bipolar Transistor (IGBT) or Field Effect Transistor (FET), and other types of electronic components can be used.

Three first screws 38 are provided. Each of the three first screws 38 has a head 38A and a shaft 38B. The first screw 38 is screwed into the screw hole 83A of the first connection portion 83 in a state where the shaft 38B is inserted into the through hole 66B. Accordingly, the distal end portion 66A of the first terminal 66 is secured to the first connection portion 83 with the first screw 38, and is electrically connected to the control board 37.

The head 38A is disposed on the first casing part 41 side. The second casing part 42 is removed from the first casing part 41, and thus the head 38A is exposed from the first casing part 41. The first screw 38 is screwed into in the Z direction in a state where the second casing part 42 is removed from the first casing part 41.

The second screw 39 includes a head 39A and a shaft 39B. The second screw 39 is screwed into the screw hole 84A of the second connection portion 84 in a state where the shaft 39B is inserted into the through hole 69B. Accordingly, the distal end portion 69A of the second terminal 69 is secured to the second connection portion 84 with the second screw 39, and is electrically connected to the control board 37.

The head 39A is disposed on the second casing part 42 side. The second casing part 42 is removed from the first casing part 41, and thus the head 39A is exposed from the first casing part 41. The second screw 39 is screwed into in the Z direction in a state where the second casing part 42 is removed from the first casing part 41.

According to the heat medium heating device 25 of the present embodiment, the first casing part 41, the second casing part 42 removable from the first casing part 41, the first screw 38 configured to secure the distal end portion 66A of the first terminal 66 to the first connection portion 83, and the second screw 39 configured to secure the distal end portion 69A of the second terminal 69 to the second connection portion 84 are provided, and the distal end portion 66A of the first terminal 66 and the first connection portion 83 are disposed facing each other in the Z direction, and the distal end portion 69A of the second terminal 69 and the second connection portion 84 are disposed facing each other in the Z direction. Thus, the first and second screws 38, 39 can be screwed into in the Z direction in a state where the second casing part 42 is removed from the first casing part 41.

Accordingly, a necessity for providing a window for operation on the side wall of the casing 31 is eliminated, and operating efficiency in screwing the first and second connection portions 83, 84 with the first and second screws 38, 39 can be increased as compared to screwing through the window for operation from the side wall side of the casing 31.

In addition, according to the configuration described above, the first and second screws 38, 39 can be screwed into while a positional relationship between the first and second connection portions 83, 84 and the first and second terminals 66, 69 is confirmed.

The vehicular air conditioning device 10 includes the heat medium heating device 25 described above, the blower 13 configured to circulate an outside air or a cabin inside air, the cooler 15 provided on a downstream side of the blower 13 and configured to cool the outside air or the air, and the radiator 16 which is provided on a downstream side of the cooler 15 and through which a heat medium heated by the PTC heater 32 is circulated, and the vehicular air conditioning device 10 can increase operating efficiency in screwing the first and second terminals 66, 69 to the first and second connection portions 83, 84.

Although the preferable embodiment of the present invention is described above in detail, the present invention is not limited to such a specific embodiment. Various modifications and changes can be made without departing from the scope and gist of the present invention described in the claims.

### INDUSTRIAL APPLICABILITY

The present invention can be applied to a heat medium heating device and a vehicular air conditioning device including the heat medium heating device.

### REFERENCE SIGNS LIST

10 Vehicular air conditioning device
11 Housing
11A Intake port
11B Discharge port
11C Flow path
13 Blower
15 Cooler
16 Radiator
16A Inlet port
16B Outlet port
17 Air mixing damper
19 Heat medium circulation circuit
21 Circulation line
23 Tank
24 Pump
25 Heat medium heating device
31 Casing
32 PTC Heater
34 Insulating member
37 Control board
38 First screw
39 Second screw
38A, 39A Head
38B, 39B Shaft
41 First casing part
42 Second casing part
45 Board accommodating portion
45A Board accommodating recess
45B Heat medium inlet port
45C Heat medium outlet port
46, 53 Flow path-forming portion
46A, 53A Fin
47, 54 Lid portion
48 First heat medium flow path
51 Screw
56 Second heat medium flow path
57 Space
61 PTC element
61a First face
61b Second face
62 First electrode plate
63 Second electrode plate
64 Compressible heat transmission sheet
65 First electrode main body
66 First terminal
66A, 69A Distal end portion
66B, 69B Through hole
66C, 66D, 69C, 69D Bending portion
68 Second electrode main body
69 Second terminal
73 Frame body
75 First guide portion
75A First opening
76 Second guide portion
76A Second opening
81 Board main body
81a Face
83 First connection portion
83A, 84A Screw hole
84 Second connection portion
85 Electronic component

1-6. (canceled)

7. A heat medium heating device comprising:
a PTC heater including a PTC element having a first face and a second face, a first electrode plate provided on the first face of the PTC element and including a first terminal, and a second electrode plate provided on the second face of the PTC element and including a second terminal;
a control board including a first connection portion to which the first terminal is connected, and a second connection portion to which the second terminal is connected;
a casing configured to house the PTC heater and the control board in a stacked state, and including a first casing part disposed on a first face side of the PTC element and including a first heat medium flow path through which a heat medium flows, and a second casing part disposed on a second face side of the PTC element, including a second heat medium flow path through which a heat medium flows, and removable from the first casing part;
a first screw configured to secure a distal end portion of the first terminal to the first connection portion;
a second screw configured to secure a distal end portion of the second terminal to the second connection portion; and
an insulating member surrounding an outer peripheral face of the PTC heater and being in contact with an inner face of the casing; wherein
a distal end portion of the first terminal and the first connection portion are disposed facing each other in a stacking direction of the PTC heater and the control board,
a distal end portion of the second terminal and the second connection portion are disposed facing each other in a stacking direction of the PTC heater and the control board,
the insulating member includes a first guide portion including a first opening through which the first terminal is inserted and a second guide portion including a second opening through which the second terminal is inserted, and
the first and second openings extend in a stacking direction of the PTC heater and the control board.

8. The heat medium heating device according to claim 7, wherein the first and second terminals include at least two bending portions.

9. The heat medium heating device according to claim 7, wherein a heat medium introduced into the casing flows branching into the first and second heat medium flow paths.

10. A vehicular air conditioning device comprising:
the heat medium heating device according to claim 7;
a blower configured to circulate an outside air or a cabin inside air;
a cooler provided on a downstream side of the blower and configured to cool the outside air or the air; and
a radiator which is provided on a downstream side of the cooler and in which the heat medium heated by the PTC heater is circulated.

11. The heat medium heating device according to claim 8, wherein a heat medium introduced into the casing flows branching into the first and second heat medium flow paths.

12. A vehicular air conditioning device comprising:
the heat medium heating device according to claim 8;
a blower configured to circulate an outside air or a cabin inside air;
a cooler provided on a downstream side of the blower and configured to cool the outside air or the air; and
a radiator which is provided on a downstream side of the cooler and in which the heat medium heated by the PTC heater is circulated.

13. A vehicular air conditioning device comprising:
the heat medium heating device according to claim 9;
a blower configured to circulate an outside air or a cabin inside air;
a cooler provided on a downstream side of the blower and configured to cool the outside air or the air; and
a radiator which is provided on a downstream side of the cooler and in which the heat medium heated by the PTC heater is circulated.
